(19) United States
(12) Patent Application Publication
(10) Pub. No.: US 2004/0175977 A1
(43) Pub. Date: Sep. 9, 2004

(54) Electrical connector

(76) Inventors: John Eaton, Brighton (GB); Michael James Cruttenden, Hove (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/733,458

(22) Filed: Dec. 11, 2003

(30) Foreign Application Priority Data
Dec. 17, 2002 (GB) 0229347.0

(51) Int. Cl. H01R 13/62

(52) U.S. Cl. 439/180

(57) ABSTRACT

An electrical connector disposed in use between a store and an aircraft or dispenser comprises a first half 10 mechanically connected to the store and a second, complementary half 12 connected to an electrical cable attached to the aircraft or dispenser, the connector second half 12 comprising a core 14 containing electrical contacts and an outer shell 24, 26, 28, 30 snap-engageable with the first connector half to securely retain the connector second half in mating engagement with the connector first half while the store is being carried by the aircraft, the outer shell being pulled off the connector first half as the store is separated from the aircraft, the outer shell being formed as a separate component or assembly, removably attached to the connector second half core.

### CROSS REFERENCE TO RELATED APPLICATION

This application claims priority to Great Britain Application No. 0229347.0 filed on Dec. 17, 2002, the entire contents of which are incorporated herein by reference.

### BACKGROUND OF THE INVENTION

This invention concerns electrical connectors for stores to be released or ejected from an aircraft. The electrical connector must be positively and safely disconnected to avoid damage to the electrical circuit and its anchoring points on the store and aircraft or dispensing system, as the store separates from the aircraft, often at considerable relative speed. This function is normally achieved by firmly securing a first half of the connector to the store and fitting a second half of the connector at the end of a flexible cable extending from the aircraft or dispensing system. A lanyard is secured between a fixed strong point on the aircraft or dispensing system and the connector second half, so that as the store separates from the aircraft, the lanyard is tensioned and releases a spring-loaded coupling sleeve on the connector, thereby allowing the two halves to separate. The length of the lanyard is shorter than the cable, which is therefore not subjected to excessive strain as the connector halves are pulled apart.

Whilst the store remains attached to the aircraft, the connector halves must be maintained together securely to resist premature separation by vibration and aerodynamic and inertial loads. In its rest position, the coupling sleeve keeps locking balls or dogs engaged in a co-operating groove in a retaining ring which is screwed onto the connector first half, to make up the electrical connection. The known connector therefore has a screw-on, pull-off action. Under certain conditions, for example very high separation speeds, this connector can fail to separate correctly. The aircraft side (second) connector half, including the electrical contacts, conductors and insulator blocks within it, can be damaged, requiring replacement before the store can be replenished. This is a lengthy operation, needing specialist tools and facilities.

### SUMMARY OF THE INVENTION

The present invention aims to mitigate or eliminate these problems and provides an electrical connector disposed in use between a store and an aircraft or dispenser, a first half of the connector being mechanically connected to one of the store or the aircraft/dispenser and a second, complementary half of the connector being connected to an electrical cable attached to the other of the store or the aircraft/dispenser, the connector second half comprising a core containing electrical contacts and an outer shell snap-engageable with the first connector half to securely retain the connector second half in mating engagement with the connector first half while the store is being carried by the aircraft/dispenser, the outer shell being pulled off the connector first half as the store is separated from the aircraft/dispenser, the outer shell being formed as a separate component or assembly, removably attached to the connector second half core. The snap-engageable connector of the invention performs well even at high separation speeds. Furthermore, even if it fails to disconnect cleanly, any resulting damage to the second half is likely to be confined to the outer shell. This is readily replaceable in the field, without disturbing the cable or its electrical connections to the core of the second connector half.

Preferably the snap-engagement is provided by a resilient finger extending axially between the first and second connector halves, the finger being attached to one of the connector halves and engageable with a detent provided on the other connector half. The finger may be attached to a ring mounted on a sleeve comprising the outer shell.

The outer shell may furthermore comprise an attachment ring rotatable about the second connector half and to which ends of a lanyard are anchored.

The outer shell may be held on the connector second half core by a threaded clamping ring. It may also be provided with EMC shielding.

The detent may be a circumferential rib formed on a collar threadingly or otherwise connected to the connector first half.

Further preferred features and advantages of the invention may be understood from an illustrative embodiment, described below with reference to the accompanying drawings.

### BRIEF DESCRIPTION OF THE DRAWINGS

FIG. 1 is an exploded perspective view of a connector embodying the invention;

FIG. 2 is a cross-sectional view of the second half of the connector of FIG. 1;

FIG. 3 shows the first half of the connector of FIG. 1 and co-operating parts of the second half;

FIG. 4 shows the two connector halves mated together, and

FIG. 5 is an enlarged view of part of FIG. 4.

### DETAILED DESCRIPTION OF THE PREFERRED EMBODIMENTS

The connector comprises a first half 10 and a second half 12. The second half comprises a core 14 containing the required electrical conductors and contacts (not shown). The electrical contacts are surrounded by a barrel 16 having keys 18 for rotational alignment of the first and second connector halves 10, 12 and proper registration of the electrical contacts in them. The connector second half further comprises an attachment ring 20 to which ends of a lanyard 22 are anchored, and an outer shell assembly comprising a moulded sleeve 28, an internally threaded clamping ring 30 and resilient metallic (e.g. spring steel) fingers 24 integrally formed with a mounting ring 26.

To assemble the second connector half, as shown in FIG. 2, the attachment ring 20 is slid over the barrel up to a shoulder 38 on the core 14. The attachment ring 20 is shown with a lanyard 22 fitted. However instead this could be an alternative cable strain relief device or interface. The next component fitted over the barrel 16 is the mounting ring 26 and fingers 24, which are pre-assembled on the sleeve 28 together with an EMC shielding ring 32. This assembly 24, 26, 28 is retained over the barrel 16 by the clamping ring 30, which is screwed onto external threads on the core 14. Tightening the ring 30 clamps the sleeve 28 and mounting ring 28 against a further shoulder 40 formed on the core 14. The attachment ring 20 is thereby trapped for free rotation on the core 14 between the shoulder 38 and the mounting ring 26.

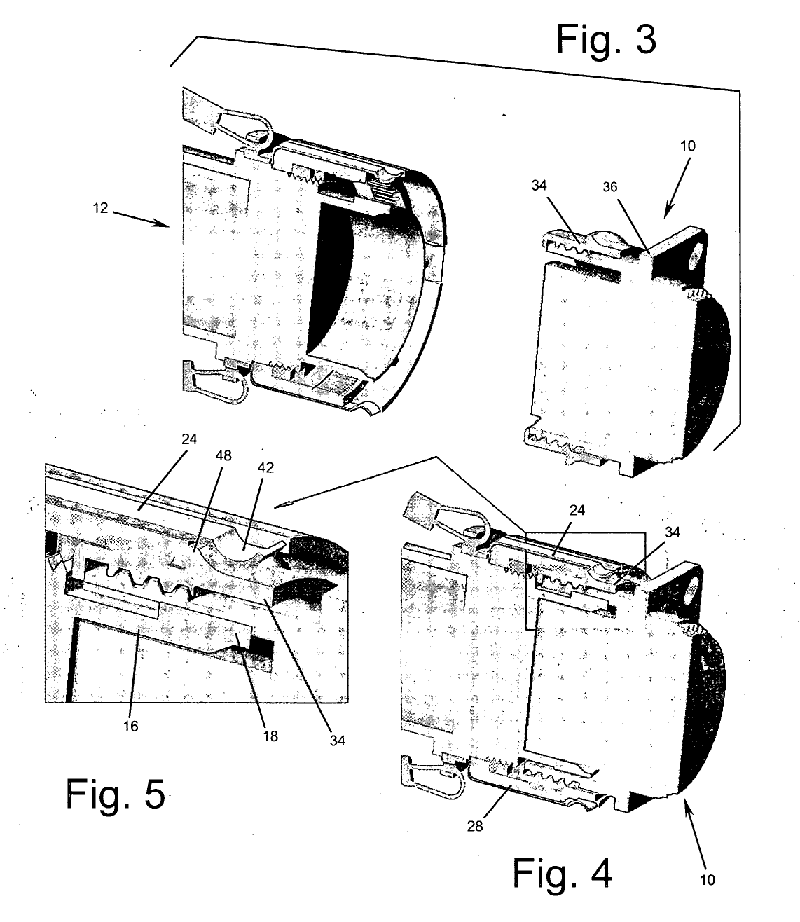

The fingers are located in axial slots formed in the exterior of the sleeve 28. The distal ends of the fingers are formed with inwardly extending curved tips 42, received in through-going slots formed in the free end of the sleeve 28. (See FIG. 3). The sleeve 28 is the main mechanical structure which provides support to the spring fingers 24 and the EMC shield 32. The spring fingers provide the means to retain the two mating halves 10, 12 of the connector together using their curved tips 42, as further explained below. Although four fingers 24 are illustrated, there could be two through to eight or more, depending on the size of the connector core components to be mated. The EMC shield 32 is optional, depending on the overall requirements for the connector EMC performance. The type of braid which can be fitted provides a full 360° screening/bonding performance.

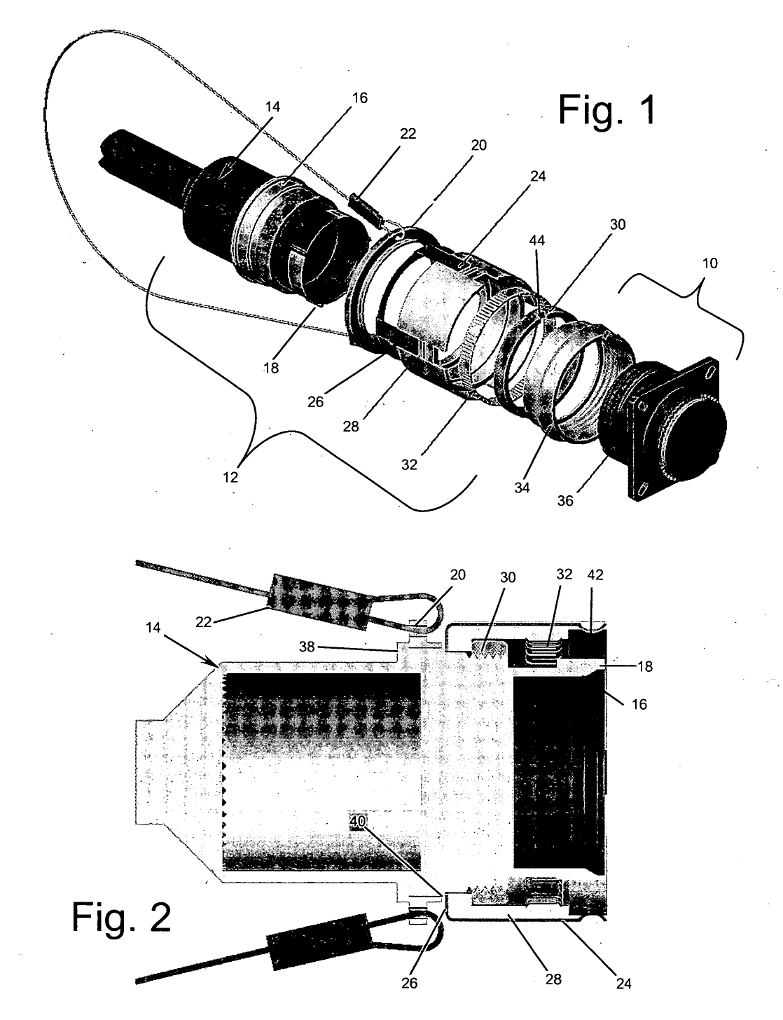

The clamping ring 30 has features (e.g. slots 44, FIG. 1) that allow the ring to be hand torqued into place using a suitable tool. This completes the assembly of the aircraft-side connector at the end of the flexible cable. On the standard store connector receptacle 36 forming part of the first connector half, the only item which needs to be added is a detent collar 34 which as shown is screwed onto external threads (see FIG. 3). Alternatively, different standard collar fittings (e.g. bayonet fittings) can be used to suit a given store connector receptacle 36.

Obviously the features of the two connector halves 10, 12 can be swapped to provide the best solution for an individual application.

The connector once assembled is simple to operate as the two halves 10, 12 are mated by first aligning the keys 18 with keyways in the other connector half (where necessary) and then pushing the two halves together. As the contacts in the core 14 and store receptacle 36 engage, the spring fingers 24 open over a shaped rib 48 on the detent collar 34 (see FIG. 5). As the electrical contacts mate fully home so the spring fingers spring back into position having moved over the rib 48. As shown,. the rib 48 has a curved profile to match the profile of the finger tips 42. To disengage the connector, the second half 12 can be pulled by the attachment ring 20 which provides a tensile load on the core 14 and therefore provides the force to push apart the spring fingers 42 over the rib 48.

The connector provides for easy and reliable mating and demating of the connector halves under extreme conditions. The connector system allows simple replacement of the mechanical retention mechanism whilst being in the field, without the need to remove electrical contacts.

1. An electrical connector disposed in use between a store and an aircraft or dispenser,
a first half of the connector being mechanically connected to one of the store or the aircraft/dispenser, and a second, complementary half of the connector being connected to an electrical cable attached to the other of the store or the aircraft/dispenser,
the connector second half comprising a core containing electrical contacts and an outer shell snap-engageable with the first connector half to securely retain the connector second half in mating engagement with the connector first half while the store is being carried by the aircraft/dispenser,
the outer shell being pulled off the connector first half as the store is separated from the aircraft/dispenser,
the outer shell being formed as a separate component or assembly, removably attached to the connector second half core.

2. An electrical connector as defined in claim 1 in which the snap-engagement is provided by a resilient finger extending axially between the first and second connector halves, the finger being attached to one of the connector halves and engageable with a detent provided on the other connector half.

3. An electrical connector as defined in claim 2 in which the finger is attached to a ring mounted on a sleeve comprising the outer shell.

4. An electrical connector as defined in claim 2 in which the detent is a circumferential rib formed on a collar connected to the connector first half.

5. An electrical connector as defined in claim 1 in which the outer shell comprises an attachment ring rotatable about the second connector half and to which ends of a lanyard are anchored.

6. An electrical connector as defined in claim 1 in which the outer shell is held on the connector second half core by a threaded clamping ring.

7. An electrical connector as defined in claim 1 in which the outer shell is provided with EMC shielding.
